(19) United States
(12) Patent Application Publication
(10) Pub. No.: US 2026/0269751 A1
(43) Pub. Date: Sep. 10, 2026

(54) MOTOR DRIVE CONTROL DEVICE, MOTOR UNIT, AND MOTOR DRIVE CONTROL METHOD

(71) Applicant: MINEBEA MITSUMI Inc., Kitasaku-gun, Nagano (JP)

(72) Inventor: Naoyuki WADA, Kitasaku-gun, Nagano (JP)

(21) Appl. No.: 18/869,342

(22) PCT Filed: May 23, 2023
(86) PCT No.: PCT/JP2023/019179

§ 371 Date: Nov. 26, 2024

(30) Foreign Application Priority Data
May 26, 2022 (JP) 2022-086015

(51) Int. Cl. H02P 6/15

(52) U.S. Cl. CPC H02P 6/157

(57) ABSTRACT

To reduce an increase in power consumption of a motor. A control circuit is configured to setting, as a commutation mode, either: a first commutation mode for commutating a coil according to a detection result of a zero crossing of a back electromotive voltage of the coil of a motor; or a second commutation mode for commutating the coil according to a target energization period; generating the drive control signal based on the commutation mode set; setting a current limit value; and stopping excitation of the coil when the current flowing through the coil reaches the current limit value. The control circuit is configured to set the current limit value to an upper limit value during a period with the commutation mode being a first commutation mode, and set the current limit value to a lower limit value smaller than the upper limit value during at least a part of the period in the second commutation mode.

### TECHNICAL FIELD

The present invention relates to a motor drive control device, a motor unit, and a motor drive control method, and for example, relates to a motor drive control device for driving a stepping motor.

### BACKGROUND ART

In the related art, a motor drive control device is known. The motor drive control device has a current limiting function for limiting a current (hereinafter, also referred to as “coil current”) flowing through the coil of the motor so as not to exceed a predetermined value (hereinafter also referred to as “current limit value”) (e.g., see Patent Document 1).

In the related art, a motor drive control device is also known. The motor drive control device detects zero crossing of the back electromotive voltage of the coil of the motor and commutates the coil (e.g., see Patent Document 2).

### CITATION LIST

### Patent Literature

Patent Document 1: JP 2018-207607 A
Patent Document 2: JP 2018-38213 A

### SUMMARY OF INVENTION

### Technical Problem

The inventor of the present application has studied a new motor drive control technology prior to the present application. Specifically, the inventor of the present application has studied a motor drive control technology. In the motor drive control technology, while the motor is controlled so that the coil current of the motor does not exceed a current limit value, the coil is commutated based on a zero crossing of a back electromotive voltage of the coil when a rotation speed of the motor is lower than a threshold, and commutation of the coil is performed according to a predetermined commutation period when the rotation speed of the motor is the threshold or more. However, the inventor of the present application has found that the motor drive control technology has the following problems.

That is, according to the motor drive control technology, the rotation speed of the motor increases as the load of the motor becomes lighter, and when the rotation speed of the motor reaches a threshold, the motor is controlled so that the rotation speed becomes the threshold or less. On the other hand, the coil current can rise to the current limit value regardless of the rotation speed of the motor. Thus, in a state with the load of the motor lightened, a coil current more than necessary flows, and the power consumption of the motor may increase.

The present invention has been made in view of the above problems, and an object of the present invention is to reduce an increase in the power consumption of the motor.

### Solution to Problem

A motor drive control device according to an exemplary embodiment of the present invention, includes:
a control circuit configured to generate a drive control signal configured to control a drive of a motor; and
a drive circuit configured to drive a coil of the motor based on the drive control signal.

The control circuit includes:
a commutation mode setting unit configured to select and set, as a commutation mode, either:
a first commutation mode for commutating the coil according to a detection result of a zero crossing of a back electromotive voltage of the coil, based on a rotation speed of the motor; or
a second commutation mode for commutating the coil according to a target energization period;
a drive control signal generation unit configured to generate the drive control signal based on the commutation mode set by the commutation mode setting unit;
a current limit value setting unit configured to set a current limit value as a reference for limiting a current flowing through the coil; and
a current limiting unit configured to instruct the drive control signal generation unit to stop excitation of the coil when the current flowing through the coil reaches the current limit value.

The current limit value setting unit is configured to set the current limit value to a first value during a period with the commutation mode being a first commutation mode, and to set the current limit value to a second value smaller than the first value during at least a part of the period in the second commutation mode.

### Advantageous Effects of Invention

The motor drive control device according to the present invention enables a reduction in increase in power consumption of the motor.

### BRIEF DESCRIPTION OF DRAWINGS

FIG. 1 is a block diagram illustrating a configuration of a motor unit according to an embodiment.

FIG. 2 is a diagram schematically illustrating a configuration of a motor.

FIG. 3 is a diagram illustrating a configuration of a control circuit in a motor drive control device according to an embodiment.

FIG. 4 is a timing chart illustrating an example of an operation of a motor and a motor drive control device according to a change in load.

FIG. 5 is a timing chart illustrating an example of a change in a coil current when a motor is driven by a motor drive control device according to an embodiment.

FIG. 6 is a flowchart illustrating a flow of a switching process of a current limit value according to an embodiment.

FIG. 7 is a flowchart illustrating a flow of a setting process for a commutation mode (step S1).

### DESCRIPTION OF EMBODIMENTS

### 1. Overview of Embodiments

First, a representative embodiment of the invention disclosed in the present application will be outlined. In the following description, reference signs in the drawings corresponding to the components of the invention will be given in parentheses as an example.

[1] A motor drive control device (3) according to an exemplary embodiment of the present invention, includes:
a control circuit (1) configured to generate a drive control signal (Sd) for controlling a drive of a motor (4); and
a drive circuit (2) configured to drive a coil (41A, 41B) of the motor based on the drive control signal.

The control circuit includes:
a commutation mode setting unit (11) configured to select and set, as a commutation mode, either:
a first commutation mode for commutating the coil according to a detection result of a zero crossing of a back electromotive voltage of the coil, based on a rotation speed of the motor; or
a second commutation mode for commutating the coil according to a target energization period;
a drive control signal generation unit (12) configured to generate the drive control signal based on the commutation mode set by the commutation mode setting unit;
a current limit value setting unit (14) configured to set a current limit value as a reference for limiting a current flowing through the coil; and
a current limiting unit (16) configured to instruct the drive control signal generation unit to stop excitation of the coil when the current flowing through the coil reaches the current limit value.

The current limit value setting unit is configured to set the current limit value to a first value (Ith1) during a period with the commutation mode being a first commutation mode, and to set the current limit value to a second value (Ith2) smaller than the first value during at least a part of the period in the second commutation mode.

[2] In the motor drive control device according to above [1],
the commutation mode setting unit may:
set the commutation mode to the first commutation mode when the rotation speed of the motor does not reach the first threshold (Sth1);

set the commutation mode to the second commutation mode when the rotation speed of the motor reaches the first threshold; and
set the commutation mode to the first commutation mode when the rotation speed of the motor decreases to the second threshold (Sth2) smaller than the first threshold when the commutation mode is the second commutation mode.

[3] In the motor drive control device according to above [1] or [2],
the current limit value setting unit may stepwisely change the current limit value from the first value to the second value when the zero crossing of the back electromotive voltage can no longer be detected after the commutation mode is switched from the first commutation mode to the second commutation mode.

[4] In the motor drive control device according to any one of above [1] to [3],
the current limit value setting unit may stepwisely change the current limit value from the second value to the first value, once the zero crossing of the back electromotive voltage can be detected when the commutation mode is the second commutation mode.

[5] In the motor drive control device according to any one of above [1] to [4],
a rate of change of the current limit value with respect to a time when the current limit value switches from the second value to the first value, may be larger than a rate of change of the current limit value with respect to a time when the current limit value switches from the first value to the second value.

[6] In the motor drive control device according to any one of above [1] to [5],
the current limit value setting unit periodically determines whether the zero crossing of the back electromotive voltage is detected, may increase the current limit value when the zero crossing of the back electromotive voltage is detected, and may decrease the current limit value when the zero crossing of the back electromotive voltage is not detected.

[7] A motor unit (5) according to an exemplary embodiment of the present invention, includes:
the motor (4); and
the motor drive control device (3) according to any one of above [1] to [6].

[8] A method according to an exemplary embodiment of the present invention, is a motor drive control method for controlling a drive of a motor by a motor drive control device.

The motor drive control method includes:
a first step (S1) of setting, by the motor drive control device, as a commutation mode, either:
a first commutation mode for commutating a coil according to a detection result of a zero crossing of a back electromotive voltage of the coil of a motor, based on a rotation speed of the motor; or
a second commutation mode for commutating the coil according to a target energization period;
a second step of generating, by the motor drive control device, a drive control signal control a drive of the motor;
a third step (S2 to S9) of setting, by the motor drive control device, a current limit value as a reference for limiting a current flowing through the coil; and
a fourth step of generating, by the motor drive control device, the drive control signal configured to stop excitation of the coil when the current flowing through the coil reaches the current limit value.

The third step includes:
a fifth step (S4 to S7) of setting, by the motor drive control device, the current limit value to a first value during a period with the commutation mode being the first commutation mode; and
a sixth step (S5 to S9) of setting, by the motor drive control device, the current limit value to a second value smaller than the first value during at least a part of the period in the second commutation mode.

### 2. Specific Examples of Embodiments

Specific examples of embodiments of the present invention will be described below with reference to the drawings. In the following description, the same reference signs are used for common components in the respective embodiments, and repeated descriptions will be omitted.

### Embodiments

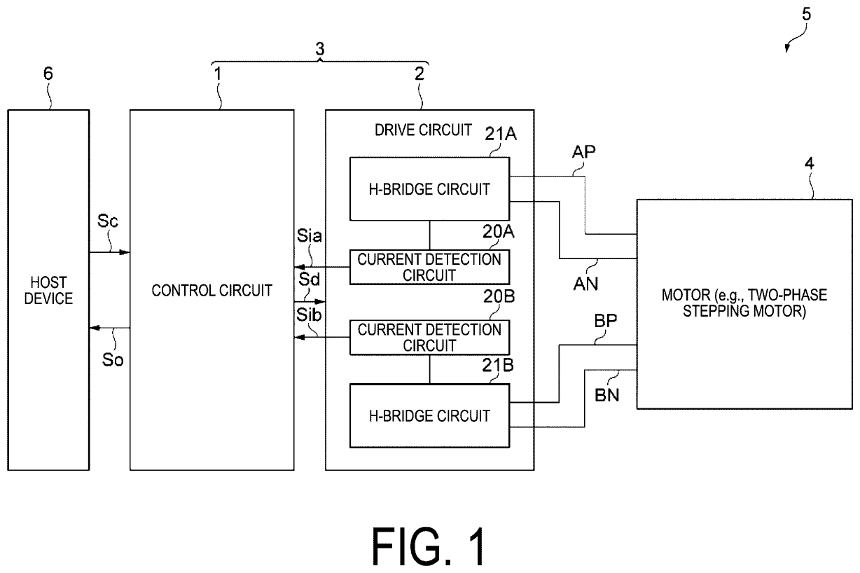

FIG. 1 is a block diagram illustrating a configuration of a motor unit 5 according to an embodiment.

As illustrated in FIG. 1, the motor unit 5 includes a motor 4 and a motor drive control device 3 for driving the motor 4. The motor unit 5 is applicable to various devices using a motor as a power source, such as an actuator applicable for HVAC (Heating Ventilation and Air-Conditioning) as an air conditioning unit for in-vehicle applications.

The motor 4 is, for example, a stepping motor. In the present embodiment, as an example, the motor 4 is assumed as a two-phase stepping motor.

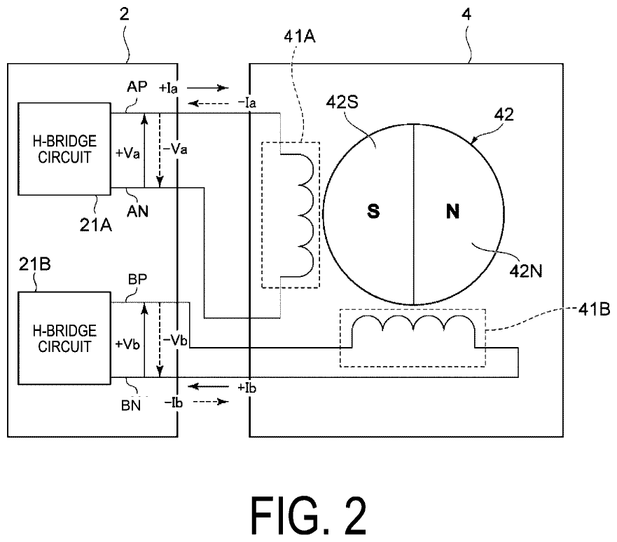

FIG. 2 is a diagram schematically illustrating a configuration of the motor 4.

As illustrated in FIG. 2, the motor 4 as a two-phase stepping motor includes an A-phase coil 41A, a B-phase coil 41B, and a rotor 42. The coils 41A and 41B are wound around a stator yoke (not illustrated) and constitute a stator together with the stator yoke. In the present embodiment, the coils 41A and 41B, when not distinguished from each other, may be each simply represented as a “coil 41”.

As illustrated in FIG. 2, the rotor 42 includes a permanent magnet subjected to multipolar magnetization along a circumferential direction such that an S-pole 42S and an N-pole 42N are alternately disposed. In FIG. 2, a case with the rotor 42 having two poles is illustrated as an example, but the number of poles of the rotor 42 is not particularly limited.

When a current flows through the coil 41A of A-phase, the stator yoke of A-phase is excited, and when a current flows through the coil 41B of B-phase, the stator yoke of B-phase is excited. When the phases of the currents flowing through the respective coils 41A and 41B are periodically switched, the rotor 42 rotates. An output shaft (not illustrated) is connected to the rotor 42, and when the output shaft is driven by the rotational force of the rotor 42, for example, the above-described function as an actuator is achieved.

The motor drive control device 3 is a device for driving the motor 4. The motor drive control device 3 controls the rotation and stop of the motor 4 by controlling the energization state of the coils 41A and 41B of respective phases of the motor 4 based on a drive command signal Sc from a host device 6, for example.

### As illustrated in FIG. 1, the motor drive control device 3 includes a control circuit 1 and a drive circuit 2.

The drive circuit 2 energizes the coils 41A and 41B of the motor 4 to drive the motor 4. The drive circuit 2 rotates the rotor 42 of the motor 4 by exciting the coils 41A and 41B of the motor 4 based on a drive control signal Sd output from the control circuit 1.

The drive circuit 2 includes, for example, an inverter circuit 21A for exciting the coil 41A of A-phase, an inverter circuit 21B for exciting the coil 41B of B-phase, a current detection circuit 20A for detecting the current of the coil 41A of A-phase, and a current detection circuit 20B for detecting the current of the coil 41B of B-phase.

The inverter circuits 21A and 21B are configured by, for example, an H-bridge circuit composed of 4 switching elements (e.g., transistors). Hereinafter, the inverter circuit 21A is also referred to as an “H-bridge circuit 21A”, and the inverter circuit 21B is also referred to as an “H-bridge circuit 21B”. The H-bridge circuit 21A and the H-bridge circuit 21B, when not distinguished, are both simply referred to as “H-bridge circuit 21”.

The H-bridge circuit 21A and the H-bridge circuit 21B have, for example, the same circuit configuration as each other. Although not illustrated, the H-bridge circuit 21 includes a plurality of switching elements (e.g., transistors) with on/off state controlled by the drive control signal Sd.

The drive circuit 2 may include a pre-drive circuit for driving the switching elements of the respective H-bridge circuits 21A and 21B based on the drive control signal Sd.

As illustrated in FIG. 2, the H-bridge circuit 21A is connected to a terminal AP at the positive pole side of the coil 41A and a terminal AN at the negative pole side of the coil 41A. The H-bridge circuit 21B is connected to a terminal BP at the positive pole side of the coil 41B and a terminal BN at the negative pole side of the coil 41B.

H-bridge circuits 21A and 21B apply voltages to the terminals AP, AN, BP and BN to energize the coils 41A and 41B. Specifically, the H-bridge circuit 21 selectively turns on and off the switching elements constituting the H-bridge circuit 21 in accordance with the drive control signal Sd supplied from the control circuit 1, thus switching the coils 41 to be excited and switching an energization direction of the coil 41.

For example, as illustrated in FIG. 2, during an “A-phase (+) excitation period” with a current +Ia flowing from the terminal AP to the terminal AN of the coil 41A, the H-bridge circuit 21A applies a voltage of, for example, “+Va” to the terminal AP with respect to the terminal AN of the coil 41A. On the other hand, during an “A-phase (−) excitation period” with a current-Ia flowing from the terminal AN to the terminal AP of the coil 41A, the H-bridge circuit 21A applies a voltage of “−Va” to the terminal AP with respect to the terminal AN of the coil 41A. During a “B-phase (+) excitation period” with a current +Ib flowing from the terminal BP to the terminal BN of the coil 41B, the H-bridge circuit 21B applies a voltage of, for example, “+Vb” to the terminal BP with respect to the terminal BN of the coil 41B. During a “B-phase (−) excitation period” with a current-Ib flowing from the terminal BP of the coil 41B to the terminal BN, the H-bridge circuit 21B applies a voltage of “−Vb” to the terminal BP with respect to the terminal BN of the coil 41B.

The current detection circuit 20A is connected to the H-bridge circuit 21A, detects a current flowing through the coil 41A, and outputs a current detection signal Sia corresponding to the magnitude of the detected current. The current detection circuit 20B is connected to the H-bridge circuit 21B, detects a current flowing through the coil 41B, and outputs a current detection signal Sib corresponding to the magnitude of the detected current.

The current detection circuits 20A and 20B include, for example, shunt resistors. The shunt resistor is, for example, connected in series with the H-bridge circuit 21 between the power supply voltage and the ground voltage of the H-bridge circuit 21, for the H-bridge circuit 21, and output voltage generated at both ends of the shunt resistor as current detection signal Sia, Sib. The current detection circuits 20A and 20B may adopt various known circuit configurations capable of detecting currents flowing through the coils 41A and 41B of the motor 4, and are not limited to the circuit configurations including the shunt resistors described above.

The control circuit 1 is a circuit for overall control of the motor drive control device 3.

The control circuit 1 is a program processing device (e.g., a microcontroller), configured such that a processor such as a CPU, various storage devices such as a RAM and a ROM, and peripheral circuits such as a timer (counter), an A/D conversion circuit, a D/A conversion circuit, and an input/output I/F circuit are connected to one another via a bus. In the present embodiment, the control circuit 1 is packaged as, for example, an IC (integrated circuit), but is not limited to this configuration. The control circuit 1 and the drive circuit 2 may be packaged together.

The control circuit 1 has a function of controlling the drive of the motor 4 by, for example, generating the drive control signal Sd, then given to the drive circuit 2.

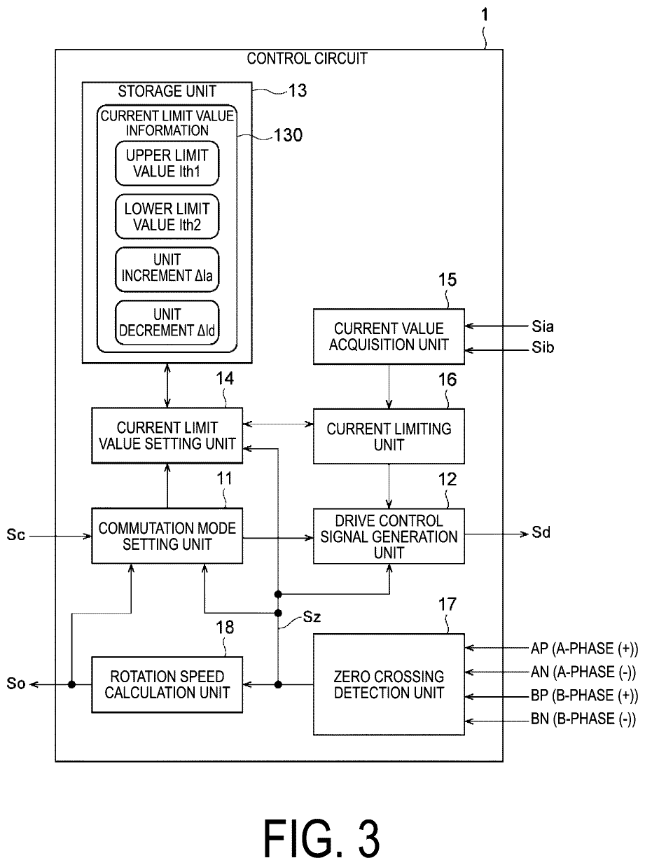

FIG. 3 is a diagram illustrating the configuration of the control circuit 1 in the motor drive control device 3 according to the embodiment.

As illustrated in FIG. 3, the control circuit 1 includes, as functional units for achieving the above functions, a commutation mode setting unit 11, a drive control signal generation unit 12, a storage unit 13, a current limit value setting unit 14, a current value acquisition unit 15, a current limiting unit 16, a zero crossing detection unit 17, and a rotation speed calculation unit 18.

In the program processing device (microcontroller) serving as the control circuit 1 described above, these functional units are achieved, for example, by a processor executing an arithmetic process using various parameters stored in the storage device according to a program stored in the storage device, and controlling the peripheral circuits such as an A/D conversion circuit and a timer. Some or all of these functional units may be implemented by dedicated circuits (hardware).

The storage unit 13 is a functional unit for storing various data necessary for motor drive control by the control circuit 1. For example, the storage unit 13 stores current limit value information 130 described later, including an upper current limit value (an example of a first value) Ith1, a lower limit value (an example of a second value) Ith2, a unit increment ΔIa, and a unit decrement ΔId.

The commutation mode setting unit 11 is a functional unit of setting a commutation mode for specifying a commutation method for the motor 4.

The motor drive control device 3 according to the present embodiment has at least two commutation modes. One is a first commutation mode for commutating the coils 41A and 41B based on the detection result of zero crossing of the back electromotive voltage of the coils 41A and 41B, and the other is a second commutation mode for commutating the coil 41 according to the target energization period. The target energization period is a target value for the length of a period with one energization pattern (excitation state of the coil 41) continued.

For example, the commutation mode setting unit 11 acquires the drive command signal Sc for the motor 4, input from outside the motor drive control device 3 (e.g., host device 6). The drive command signal Sc includes, for example, information specifying a rotational position of the motor 4, information instructing the stop of rotation of the motor 4, or the like. The drive command signal Sc is, for example, a PWM signal. The commutation mode setting unit 11 acquires information (target rotational position) of a target rotational position of the motor 4 by analyzing the drive command signal Sc, sets the commutation mode to a first commutation mode or a second commutation mode, and instructs the drive control signal generation unit 12 to drive the motor 4. Details of the commutation mode setting method by the commutation mode setting unit 11 will be described below.

The zero crossing detection unit 17 is a functional unit for monitoring the voltages of the coils 41A and 41B and detecting zero crossing of the back electromotive voltage generated in the coils 41A and 41B. Here, the zero crossing of the back electromotive voltage means a state such that the back electromotive voltage generated at both ends of the coil 41, not excited, changes from positive to negative or from negative to positive.

The zero crossing detection unit 17 monitors the voltage between the terminal AP and the terminal AN as the voltage of the coil 41A and the voltage between the terminal BP and the terminal BN as the voltage of the coil 41B. The zero crossing detection unit 17, when detecting the zero crossing of the back electromotive voltage of the coils 41A or 41B, outputs a zero crossing detection signal Sz indicating that zero crossing has been detected.

The rotation speed calculation unit 18 is a function unit calculating the rotation speed of the motor 4. When the zero crossing of the back electromotive voltage of the coil 41 is periodically detected, the rotation speed calculation unit 18 calculates the rotation speed of the motor 4 based on the zero crossing detection signal Sz output from the zero crossing detection unit 17. For example, the rotation speed calculation unit 18 calculates the rotation speed of the motor 4 based on the cycle for the zero crossing detection signal Sz outputted in the first commutation mode. On the other hand, when the back electromotive voltage is not detected in the second commutation mode, the rotation speed calculation unit 18 calculates the rotation speed of the motor 4 based on the target energization period predetermined in the second commutation mode, for example. The rotation speed calculation unit 18 generates an output signal So including information on the calculated rotation speed. The output signal So is output, for example, to the outside of the motor drive control device 3 (e.g., host device 6) and is input to the commutation mode setting unit 11.

The drive control signal generation unit 12 generates the drive control signal Sd based on the commutation mode set by the commutation mode setting unit 11. The drive control signal Sd is a signal for controlling on and off of each switching element of the H-bridge circuits 21A and 21B, and is, for example, a PWM signal.

The drive control signal generation unit 12 generates and outputs the drive control signal Sd such that the coil 41A of A-phase and the coil 41B of B-phase are excited at a predetermined timing based on a predetermined excitation method in order to move the rotor 42 to the target rotational position or the target standby position. Here, the predetermined excitation method may be any excitation method capable of detecting the back electromotive voltage of the coil 41, for example, a known one-phase excitation method or a one-two-phase excitation method.

When generating the drive control signal Sd by the one-phase excitation method, the drive control signal generation unit 12 generates and outputs the drive control signal Sd such that the energization states of the A-phase and B-phase coils 41A and 41B are switched in the order of “A-phase (+) excitation period”, “B-phase (+) excitation period”, “A-phase (−) excitation period”, and “B-phase (−) excitation period”, for example.

At this time, the switching of each excitation period, that is, the commutation of the coils 41A and 41B is performed according to the commutation mode set by the commutation mode setting unit 11.

Specifically, when the first commutation mode is specified as the commutation mode, the drive control signal generation unit 12 commutates the coils 41A and 41B every time the zero crossing of the back electromotive voltage is detected by the zero crossing detection unit 17. In the case with the motor 4 driven by the one-phase excitation method as described above, for example, when the zero crossing detection unit 17 outputs the zero crossing detection signal Sz in the “A-phase (+) excitation period”, the drive control signal generation unit 12 switches from the “A-phase (+) excitation period” to the “B-phase (+) excitation period”.

When the second commutation mode is specified as the commutation mode, the drive control signal generation unit 12 commutates the coils 41A and 41B based on the target energization period.

For example, the drive control signal generation unit 12 includes a timer (counter) and starts measuring time by the timer when the “A-phase (+) excitation period” starts, and switches the “A-phase (+) excitation period” to the “B-phase (+) excitation period” when the measurement time reaches the target energization period.

Here, information on the target energization period may be stored in advance in the drive control signal generation unit 12 or the storage unit 13, or may be calculated by the drive control signal generation unit 12. For example, information on the target rotation speed of the motor 4 and information on the energization angle indicating the magnitude of the electric angle with the coil of one phase continuously energized in one direction according to the excitation method, may be stored in advance in the storage unit 13. Then the drive control signal generation unit 12 may calculate the target energization period based on the information on the target rotation speed and the information on the energization angle read from the storage unit 13.

When the zero crossing of the back electromotive voltage is detected in the second commutation mode, the drive control signal generation unit 12 may commutate the coils 41A and 41B according to the detection of zero crossing of the back electromotive voltage (input of zero crossing detection signal Sz) as in the first commutation mode. That is, the drive control signal generation unit 12 may commutate the coils 41A and 41B based on the target energization period when zero crossing of the back electromotive voltage is not detected in the second commutation mode, and may commutate the coils 41A and 41B according to the detection of zero crossing of the back electromotive voltage without depending on the target energization period even in the second commutation mode, when zero crossing of the back electromotive voltage is detected in the second commutation mode.

The current value acquisition unit 15 is a functional unit for acquiring values of currents flowing through the coils 41A and 41B of the respective phases of the motor 4. The current value acquisition unit 15 receives the current detection signals Sia and Sib output from the current detection circuits 20A and 20B of the drive circuit 2. The current value acquisition unit 15 includes, for example, an A/D conversion circuit, converts the voltage as the current detection signal Sia into a digital value by the A/D conversion circuit, and outputs the digital value as the current value of the coil 41A of the A-phase. Similarly, the current value acquisition unit 15 converts the voltage as the current detection signal Sib into a digital value by the A/D conversion circuit, and outputs the digital value as the current value of the coil 41B of the B-phase.

The current limit value setting unit 14 is a functional unit for setting the current limit value.

The current limit value is a reference value for limiting the current flowing through the coil 41 of the motor 4, or in other words, a value for setting the upper limit of the current of the coil 41.

The current limit value setting unit 14 sets the current limit value, based on the information of the commutation mode set by the commutation mode setting unit 11, the zero crossing detection signal Sz output from the zero crossing detection unit 17, and the current limit value information 130 stored in the storage unit 13. The details of how to set the current limit value will be described below.

The current limiting unit 16 monitors the current flowing through the coil 41 of the motor 4, and is a function unit controlling the current so that the current does not exceed the current limit value. The current monitoring by the current limiting unit 16 is performed for each phase of the motor 4. For example, during the “A-phase (+) excitation period” and the “A-phase (−) excitation period” with the coil 41A of the A-phase excited, the current (current detection signal Sia) of the coil 41A of the A-phase is monitored, and during the “B-phase (+) excitation period” and the “B-phase (−) excitation period” with the coil 41B of the B-phase excited, the current (current detection signal Sib) of the coil 41B of the B-phase is monitored.

When the current flowing through the coil 41 reaches the current limit value, the current limiting unit 16 instructs the drive control signal generation unit 12 to stop the excitation of the coil 41. For example, during the period with the coil 41A of the A-phase excited, the current limiting unit 16 compares the current value (absolute value) of the coil 41A output from the current value acquisition unit 15 with the current limit value (absolute value) set by the current limit value setting unit 14. When the current value of the coil 41A becomes the current limit value or more, the current limiting unit 16 outputs a signal for a predetermined period of time instructing to stop the excitation of the coil 41A, that is, to turn off each switching element of the H-bridge circuit 21A by the drive control signal Sd. The current limiting unit 16 limits the current of the coil 41B of the B-phase in the same manner during the period with the coil 41B of the B-phase excited.

The drive control signal generation unit 12 generates the drive control signal Sd so as to stop excitation of the coil 41 while the current limiting unit 16 is outputting a signal to instruct stopping excitation of the coil 41. For example, in the “A-phase (+) excitation period”, when the current limiting unit 16 outputs a signal instructing to stop excitation of the coil 41A in the A-phase, the drive control signal generation unit 12 generates the drive control signal Sd so as to turn off each switching element in the H-bridge circuit 21A of the A-phase. As a result, power supply to the coil 41A of the A-phase is stopped, so that the current of the coil 41A of the A-phase decreases and is limited so as not to exceed the current limit value. The current of the coil 41B of the B-phase is also limited by the same method.

A method of setting the commutation mode will now be described.

The commutation mode setting unit 11 selects either the first commutation mode or the second commutation mode based on the rotation speed of the motor 4, then sets as the commutation mode.

For example, when the load of the motor 4 is heavy and the rotation speed of the motor 4 is relatively slow, zero crossing of the back electromotive voltage of the coil 41 is likely to be detected. Thus, when the rotation speed of the motor 4 does not reach the first threshold Sth1, the commutation mode setting unit 11 sets the commutation mode to the first commutation mode.

By setting the commutation mode to the first commutation mode, the coil 41 is commutated according to the detection of zero crossing of the back electromotive voltage, so that the motor 4 can be rotated with an appropriate rotation speed and torque following the magnitude of the load.

On the other hand, when the coil 41 commutates according to the detection of zero crossing of the back electromotive voltage in the first commutation mode, the rotation speed of the motor 4 increases as the load on the motor 4 becomes lighter, and the zero crossing of the back electromotive voltage becomes difficult to be detected. Thus, the commutation mode setting unit 11 sets the commutation mode to the second commutation mode when the rotation speed of the motor 4 reaches the first threshold Sth1.

By setting the commutation mode to the second commutation mode, the coil 41 is commutated according to the target energization period, so that the motor 4 can be reliably rotated while avoiding the step-out of the motor 4. At this time, since the motor 4 rotates at the rotation speed corresponding to the target energization period, the increase in the rotation speed is reduced.

As described above, when zero crossing of the back electromotive voltage is detected in the second commutation mode, the coil 41 may be commutated according to the detection of zero crossing of the back electromotive voltage as in the first commutation mode. In this case, the motor 4 rotates at a rotation speed corresponding to the magnitude of the load.

The commutation mode setting unit 11 sets the commutation mode to the first commutation mode once the rotation speed of the motor 4 decreases to the second threshold Sth2 when the commutation mode is the second commutation mode. Here, the second threshold Sth2 is a value different from the first threshold Sth1, for example, second threshold Sth2<first threshold Sth1.

According to this, for example, when the load of the motor 4 changes to increase and the rotation speed decreases, the second commutation mode automatically returns to the first commutation mode, and the motor 4 can be driven by an appropriate rotation speed and torque corresponding to the load. Furthermore, regarding the threshold of the rotation speed of the motor 4, by setting the second threshold Sth2 and the first threshold Sth1 to mutually different values, frequent switching of the commutation mode due to variations in the rotation speed (load) of the motor 4 can be prevented.

Next, a method of setting the current limit value will be described.

As described above, when the load of the motor 4 is lightened and the motor 4 is rotating in the second commutation mode, the coil current can rise to the current limit value without depending on the rotation speed of the motor 4, so that the coil current flows more than necessary and the power consumption may increase. Thus, the motor drive control device 3 according to the present embodiment has a function of varying the current limit value.

Specifically, the current limit value setting unit 14 sets the current limit value to the upper limit value Ith1 as a first value, during the period for the commutation mode being the first commutation mode, and sets the current limit value to the lower limit value Ith2 (<upper limit value Ith1) as a second value smaller than the first value, during at least a part of the period in the second commutation mode.

For example, the current limit value setting unit 14 periodically determines whether zero crossing of the back electromotive voltage is detected, increases the current limit value when zero crossing of the back electromotive voltage is detected, and decreases the current limit value when zero crossing of the back electromotive voltage is not detected. The switching process of the current limit value will be described in detail below.

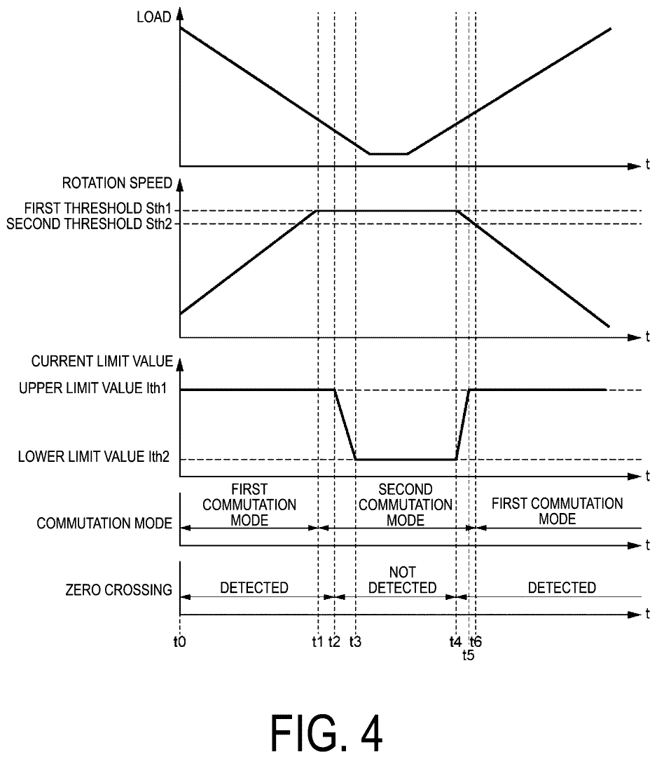

FIG. 4 is a timing chart illustrating an example of the operation of the motor 4 and the motor drive control device 3 as the load changes.

In FIG. 4, the horizontal axis represents time t. In FIG. 4, the magnitude of the load, the rotation speed of the motor 4, the current limit value, the commutation mode, and the detection state of zero crossing of the back electromotive voltage, are illustrated from the top to the bottom in the paper.

For example, as illustrated in FIG. 4, at time t0, the rotation speed of the motor 4 has not reached the first threshold Sth1. Thus, the commutation mode setting unit 11 sets the commutation mode to a first commutation mode. The current limit value setting unit 14 sets the current limit value to the upper limit value Ith1 as the first value. Thus, the motor 4 is controlled so that the coil current does not exceed the upper limit value Ith1 while rotating at the rotation speed corresponding to the load. The information of the upper limit value Ith1 is stored in the storage unit 13 as the current limit value information 130, for example, and the current limit value setting unit 14 reads the information from the storage unit 13 and uses the information.

Similarly after time t0, since the motor 4 is driven and controlled by the first commutation mode, the rotation speed of the motor 4 increases as the load decreases. When the rotation speed of the motor 4 reaches the first threshold Sth1 at time t1, the commutation mode setting unit 11 switches the commutation mode from the first commutation mode to the second commutation mode. As a result, the drive control signal generation unit 12 commutates the coil 41 based on the predetermined target energization period, so that the motor 4 rotates at the rotation speed corresponding to the target energization period.

The current limit value setting unit 14 starts the process of switching the current limit value from the upper limit value Ith1 as the first value to the lower limit value Ith2 as the second value, when determining that the zero crossing of the back electromotive voltage cannot be detected after the commutation mode is switched from the first commutation mode to the second commutation mode.

For example, as illustrated in FIG. 4, suppose that the zero crossing of the back electromotive voltage cannot be detected at time t2 after the commutation mode is switched from the first commutation mode to the second commutation mode at time t1. At this time, the current limit value setting unit 14 changes (lowers) the current limit value stepwisely from the upper limit value Ith1 to the lower limit value Ith2.

For example, the current limit value setting unit 14 changes the current limit value stepwisely in synchronization with the determination of whether the zero crossing of the back electromotive voltage is detected. Specifically, the current limit value setting unit 14 periodically determines whether the zero crossing of the back electromotive voltage is detected, and lowers the current limit value by a unit amount depending on the determination result.

For example, the current limit value setting unit 14 determines whether zero crossing detection signal Sz has been output during a certain period (whether zero crossing has been detected), and when the zero crossing detection signal Sz has not been output during the certain period, the current limit value is decreased by a unit decrement ΔId. The information on the lower limit value Ith1 and the information on the unit decrement ΔId are stored in the storage unit 13 as the current limit value information 130, for example, and the current limit value setting unit 14 reads and uses the information from the storage unit 13.

Since zero crossing of back electromotive voltage cannot be detected after time t2, the current limit value setting unit 14 decreases the current limit value by unit decrement ΔId every certain period. Then, the current limit value is assumed to reach lower limit value Ith2 at time t3. At this time, the current limit value setting unit 14 stops the process of decreasing the current limit value. Thus, after time t3, the motor 4 is controlled so that the coil current does not exceed the lower limit value Ith2 while rotating at a rotation speed corresponding to the target energization period.

The current limit value setting unit 14 starts the process of switching the current limit value from the lower limit value Ith2 as the second value to the upper limit value Ith1 as the first value, once the zero crossing of the back electromotive voltage can be detected when the commutation mode is the second commutation mode.

For example, as illustrated in FIG. 4, suppose that the load starts to increase after time t3 and the zero crossing of back electromotive voltage starts to be detected at time t4. At this time, the current limit value setting unit 14 stepwisely changes (increases) the current limit value from the lower limit value Ith2 to the upper limit value Ith1. Specifically, the current limit value setting unit 14 periodically determines whether the zero crossing of the back electromotive voltage is detected, and increases the current limit value by a unit amount depending on the determination result.

For example, the current limit value setting unit 14 determines whether zero crossing detection signal Sz has been output during a certain period (whether zero crossing has been detected), and when the zero crossing detection signal Sz has not been output during the certain period, the current limit value is increased by a unit increment ΔIa. The information on the unit increment ΔIa is stored in the storage unit 13 as the current limit value information 130, for example, and the current limit value setting unit 14 reads and uses the information from the storage unit 13.

The current limit value setting unit 14 increases the current limit value by the unit increment ΔIa each time zero crossing of back electromotive voltage is detected after time t4. When the current limit value reaches the upper limit value Ith1 at time t5, the current limit value setting unit 14 stops the process for increasing the current limit value.

After time t4, the commutation mode is the second commutation mode, but the zero crossing of the back electromotive voltage is detected. Thus, the drive control signal generation unit 12 may commutate the coil 41 in response to the detection of the zero crossing of the back electromotive voltage, without depending on the set commutation mode (second commutation mode). Thus, in the period after time t4, the rotation speed of the motor 4 decreases as the load increases.

Then, at time t6, the rotation speed of the motor 4 is assumed to decrease to the second threshold Sth2. At this time, the commutation mode setting unit 11 switches the commutation mode from the second commutation mode to the first commutation mode. Thus, the motor 4 is again controlled so that the coil current does not exceed the upper limit value Ith1 while rotating at the rotation speed corresponding to the load.

At this time, since the zero crossing of the back electromotive voltage is periodically detected in accordance with the rotation speed of the motor 4, the current limit value setting unit 14 maintains the current limit value at the upper limit value Ith1 as the first value.

Here, as illustrated in FIG. 4, the rate (absolute value) of change with respect to the time, in the current limit value when the current limit value is switched from the lower limit value (second value) Ith2 to the upper limit value (first value) Ith1, and the rate (absolute value) of change with respect to the time, in the current limit value when the current limit value is switched from the upper limit value Ith1 to the lower limit value Ith2, may be different from each other. For example, the unit increment ΔIa and the unit decrement ΔId may be different from each other.

Preferably, as illustrated in FIG. 4, the rate (absolute value) of change with respect to the time, in the current limit value when the current limit value is switched from the lower limit value Ith2 to the upper limit value Ith1, is larger than the rate (absolute value) of change with respect to the time, in the current limit value when the current limit value is switched from the upper limit value Ith1 to the lower limit value Ith2. For example, unit increment ΔIa >unit decrement ΔId.

In other words, as illustrated in FIG. 4, the time (period from time t4 to time t5) for the current limit value to reach the upper limit value Ith1 from the lower limit value Ith2 is preferably shorter than the time (period from time t2 to time t3) for the current limit value to reach the lower limit value Ith2 from the upper limit value Ith1. This is because a timing when the current limit value is switched from the lower limit value Ith2 to the upper limit value Ith1 corresponds to a timing when the load increases. Thus, by shortening the time for the current limit value to reach the upper limit value Ith1 from the lower limit value Ith2 and quickly increasing the current limit value as described above, the shortage can be avoided of rotational torque due to the increase in the load.

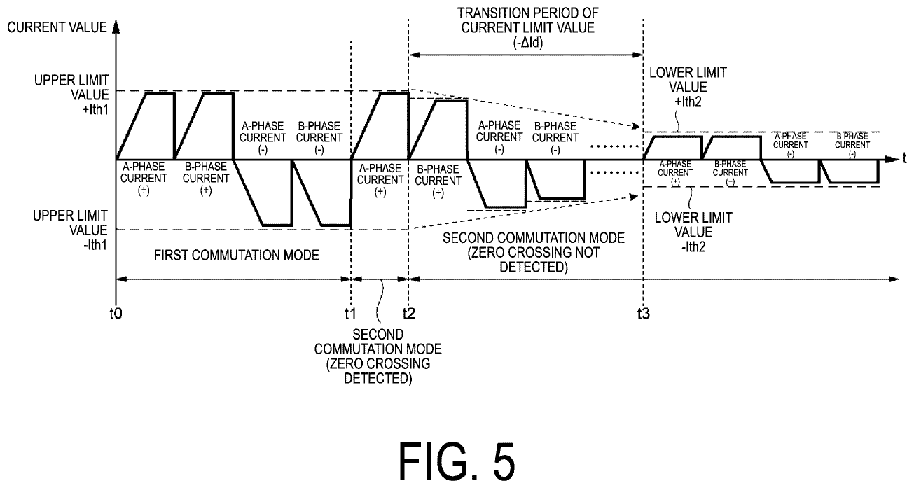

FIG. 5 is a timing chart illustrating an example of a change in the coil current when the motor 4 is driven by the motor drive control device 3 according to the embodiment.

In FIG. 5, the horizontal axis represents time t, and the vertical axis represents current. FIG. 5 illustrates temporal changes in the current of the coil 41A in A-phase and the current of the coil 41B in B-phase when the current limit value is decreased from the upper limit value Ith1 to the lower limit value Ith2 in the case with the motor 4 driven by the one-phase excitation method. For example, time t0 to t3 in FIG. 5 correspond to time t0 to t3 in the timing chart of FIG. 4.

In FIG. 5, for convenience of illustration, the current of the coil 41A in A-phase (A-phase current) and the current of the coil 41B in B-phase (B-phase current) are indicated by the same solid line, and a description for specifying the coil 41 in the phase flowing the current is added in the vicinity of the solid line.

As illustrated in FIG. 5, for example, during the period from time t0 to time t1 when the motor 4 is driven and controlled in the first commutation mode, the drive control signal generation unit 12 switches the coil 41 to be excited according to the detection of the zero crossing of the back electromotive voltage. In the excitation period of each phase, when the current of coil 41 is smaller than the absolute value |Ith1| of the upper limit value, the drive control signal generation unit 12 continues excitation of the coil 41 in one direction. When the current of coil 41 reaches the absolute value |Ith1| of the upper limit value, the drive control signal generation unit 12 repeats operation of: stopping excitation of the coil 41 in response to an instruction from the current limiting unit 16; and resuming excitation of the coil 41 after a lapse of a certain period.

After this, when the load of the motor 4 gradually decreases and the rotation speed of the motor 4 reaches the first threshold Sth1 at time t1, the commutation mode is switched from the first commutation mode to the second commutation mode. After the commutation mode is switched to the second commutation mode, when the zero crossing of the back electromotive voltage of the coil 41 is no longer detected at time t2, the switching process of the current limit value from the upper limit value Ith1 to the lower limit value Ith2 is started.

The current limit value decreases stepwisely from the upper limit value Ith1 after time t2 and reaches the lower limit value Ith2 at time t3. During the period from time t2 to time t3, since the current limit value changes stepwisely as described above, the current of the coil 41 also changes stepwisely as illustrated in FIG. 5.

Although not illustrated, similarly when the commutation mode changes from the second commutation mode to the first commutation mode, the current limit value changes from the lower limit value Ith2 to the upper limit value Ith1, so that the current of the coil 41 also changes stepwisely.

Next, the flow of the switching process of the current limit value will be described.

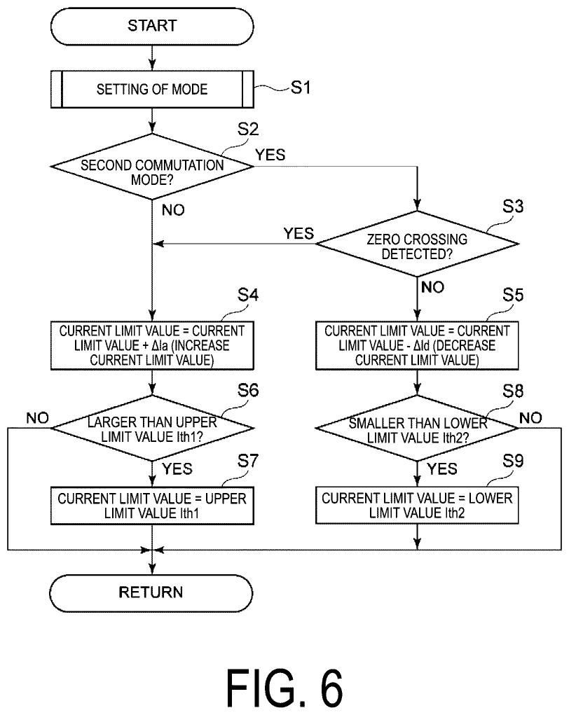

FIG. 6 is a flowchart illustrating a process flow of switching the current limit value according to the embodiment.

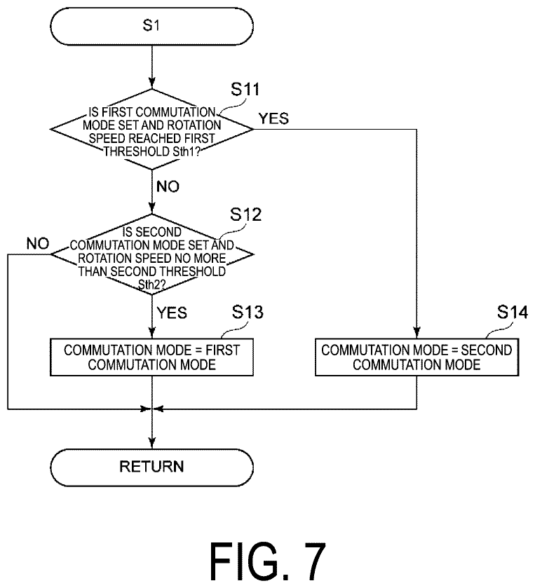

For example, first, the control circuit 1 sets the commutation mode (step S1). The commutation mode setting process in step S1 is executed according to the flow illustrated in FIG. 7, for example.

FIG. 7 is a flowchart illustrating the flow of the commutation mode setting process (step S1).

In the commutation mode setting process, first, the commutation mode setting unit 11 determines whether the commutation mode at that time is the first commutation mode and whether the rotation speed of the motor 4 reaches the first threshold Sth1 (step S11).

When the commutation mode is the first commutation mode and the rotation speed of the motor 4 reaches the first threshold Sth1 (step S11: YES), the commutation mode setting unit 11 sets the commutation mode to the second commutation mode (step S14).

On the other hand, when the commutation mode is not the first commutation mode and/or the rotation speed of the motor 4 does not reach the first threshold Sth1 (step S11: NO) in step S11, the commutation mode setting unit 11 determines whether the commutation mode at that time is the second commutation mode and the rotation speed of the motor 4 does fall below the second threshold Sth2 (step S12).

When the commutation mode is the second commutation mode and the rotation speed of the motor 4 is the second threshold Sth2 (step S12: YES) or less, the commutation mode setting unit 11 sets the commutation mode to the first commutation mode (step S14).

On the other hand, when the commutation mode is not the second commutation mode and/or the rotation speed of the motor 4 does not fall below the second threshold Sth2 (step S12: NO) in step S12, the commutation mode setting unit 11 does not change the commutation mode.

After the setting process of the commutation mode described above (step S1), as illustrated in FIG. 6, the control circuit 1 determines whether the commutation mode is the second commutation mode (step S2).

When the commutation mode is not the second commutation mode, that is, when the commutation mode is the first commutation mode (step S2: NO), the control circuit 1 increases the current limit value (step S4).

Specifically, the current limit value setting unit 14 calculates a value obtained by adding the unit increment ΔIa to the current limit value at that time.

Next, the current limit value setting unit 14 determines whether the value calculated in step S4 is larger than the upper limit value Ith1 (step S6). When the value calculated in step S4 is not larger than the upper limit value Ith1 (step S6: NO), the current limit value setting unit 14 sets the value calculated in step S4 as the current limit value, and the control circuit 1 repeats the processes of steps S1 to S9.

On the other hand, when the value calculated in step S4 is larger than the upper limit value Ith1 (step S6: YES) in step S6, the current limit value setting unit 14 sets the upper limit value Ith1 as the current limit value (step S7). After this, the control circuit 1 repeats the processes of steps S1 to S9.

On the other hand, when the commutation mode is the second commutation mode (step S2: YES) in step S2, the control circuit 1 determines whether the zero crossing of the back electromotive voltage is detected (step S3). When the zero crossing of the back electromotive voltage is detected (step S3: YES), the control circuit 1 performs the processes of steps S4 to S7 described above.

When the zero crossing of the back electromotive voltage is not detected (step S3: NO), the control circuit 1 decreases the current limit value (step S5). Specifically, the current limit value setting unit 14 calculates a value obtained by subtracting the unit decrement ΔId from the current limit value at that time.

Next, the current limit value setting unit 14 determines whether the value calculated in step S5 is smaller than the lower limit value Ith2 (step S8). When the value calculated in step S5 is not smaller than the lower limit value Ith2 (equal to or larger than the lower limit value Ith2) (step S8: NO), the current limit value setting unit 14 sets the value calculated in step S5 as the current limit value, and the control circuit 1 repeats the processes of steps S1 to S9.

On the other hand, when the value calculated in step S5 is smaller than the lower limit value Ith2 (step S8: YES) in step S8, the current limit value setting unit 14 sets the lower limit value Ith2 as the current limit value (step S9). After this, the control circuit 1 repeats the processes of steps S1 to S9.

As described above, in the motor drive control device 3 according to the present embodiment, the control circuit 1 sets the current limit value to the first value (upper limit value Ith1) during a period with the commutation mode being the first commutation mode, and sets the current limit value to the second value (lower limit value Ith2) smaller than the first value during at least a part of the period in the second commutation mode.

This enables to prevent the current of the coil 41 from becoming unnecessarily large and the power consumption of the motor 4 from increasing, when the load is lightened and the rotation speed of the motor 4 is lowered to perform the drive control of the motor 4 in the second commutation mode.

In addition, when the zero crossing of the back electromotive voltage cannot be detected after the commutation mode is switched from the first commutation mode to the second commutation mode, the control circuit 1 stepwisely changes (decreases) the current limit value from the first value (upper limit value Ith1) to the second value (lower limit value Ith2).

This enables to prevent the current of the coil 41 from suddenly decreasing and the operation of the motor 4 from becoming unstable, when the commutation mode shifts from the first commutation mode to the second commutation mode.

In addition, once the zero crossing of the back electromotive voltage can be detected when the commutation mode is in the second commutation mode, the control circuit 1 stepwisely changes (increases) the current limit value from the second value (lower limit value Ith2) to the first value (upper limit value Ith1).

This enables to raise the coil current before the rotation speed of the motor 4 decreases due to an increase in the load and the commutation mode completely shifts from the second commutation mode to the first commutation mode, thus preventing the motor 4 from causing step-out due to insufficient coil current in the first commutation mode. Further, stepwise increasing the current limit value enables to prevent the current of the coil 41 from rapidly increasing and the operation of the motor 4 from becoming unstable.

As described above, the rate of change with respect to the time, in the current limit value when the current limit value is switched from the second value (lower limit value Ith2) to the first value (upper limit value Ith1), is preferably larger than the rate of change with respect to the time, in the current limit value when the current limit value is switched from the first value (upper limit value Ith1) to the second value (lower limit value Ith2).

As a result, the unnecessary increase of the coil current to the motor 4 can be reduced more quickly when the load is reduced, while the coil current required for driving the motor 4 can be supplied more quickly when the load is increased, so that the prevention of power consumption and the stability of the operation of the motor 4 can be balanced.

The control circuit 1 may periodically determine whether the zero crossing of the back electromotive voltage is detected, and may increase the current limit value when the zero crossing of the back electromotive voltage is detected, and may decrease the current limit value when the zero crossing of the back electromotive voltage is not detected.

This enables the current limit value to be adjusted according to the variation of the load of the motor 4, thus achieving more stable driving of the motor 4.

### Variation of Embodiments

The invention made by the present inventor has been specifically described above based on the embodiments, but the present invention is not limited to the embodiments, and it goes without saying that the present invention can be changed in various ways within the scope not departing from the gist of the present invention.

For example, the number of phases of the stepping motor as the motor 4 according to the above embodiments is not limited to two-phase. The motor 4 according to the above embodiments is not limited to a stepping motor. For example, the motor may be a brushless DC motor.

In the above embodiments, the current limit value is changed stepwisely in synchronization with the determination of whether the zero crossing of the back electromotive voltage is detected. However, the current limit value may be changed stepwisely for each unit time. For example, when the zero crossing of the back electromotive voltage cannot be detected in the second commutation mode, the current limit value may be stepwisely decreased from the upper limit value Ith1 to the lower limit value Ith2 for each unit time, and when the zero crossing of the back electromotive voltage can be detected in the second commutation mode, the current limit value may be stepwisely increased from the lower limit value Ith2 to the upper limit value Ith1 for each unit time.

Further, the above-described flowchart illustrates an example for describing the operation, and is not limited to this example. That is, the steps illustrated in the respective drawings of the flowchart are specific examples, and are not limited to this flow. For example, the order of some processes may be changed, other processes may be inserted between each process, or some processes may be performed in parallel.

### REFERENCE SIGNS LIST

1 Control circuit; 2 Drive circuit; 3 Motor drive control device; 4 Motor; 5 Motor unit; 6 Host device; 11 Commutation mode setting unit; 12 Drive control signal generation unit; 13 Storage unit; 14 Current limit value setting unit; 15 Current value acquisition unit; 16 Current limiting unit; 17 Zero crossing detection unit; 18 Rotation speed calculation unit; 20A, 20B Current detection circuit; 21, 21A, 21B H-bridge circuit (Inverter circuit); 42 rotor; 42S S-pole; 42N N-pole; 41, 41A, 41B Coil; 130 Current limit value information; AP, AN, BP, BN Terminal of coil 41A, 41B; Ith1 Upper limit value (Example of First value); Ith2 Lower limit value (Example of Second value); ΔIa Unit increment; ΔId Unit decrement; Sc Drive command signal; Sd Drive control signal; Sia, Sib Current detection signal; So Output signal; Sth1 First threshold; Sth2 Second threshold; Sz Zero crossing detection signal.

1. A motor drive control device comprising:
a control circuit configured to generate a drive control signal configured to control a drive of a motor; and
a drive circuit configured to drive a coil of the motor based on the drive control signal, wherein
the control circuit configured to:
setting, as a commutation mode, either
a first commutation mode for commutating the coil according to a detection result of a zero crossing of a back electromotive voltage of the coil, based on a rotation speed of the motor, or
a second commutation mode for commutating the coil according to a target energization period,
generating the drive control signal based on the commutation mode set,
setting a current limit value as a reference for limiting a current flowing through the coil, and
stopping excitation of the coil when the current flowing through the coil reaches the current limit value, wherein
the control circuit is configured to set the current limit value to a first value during a period with the commutation mode being a first commutation mode, and to set the current limit value to a second value smaller than the first value during at least a part of the period in the second commutation mode.

2. The motor drive control device according to claim 1, wherein
the control circuit
sets the commutation mode to the first commutation mode when the rotation speed of the motor does not reach a first threshold,
sets the commutation mode to the second commutation mode when the rotation speed of the motor reaches the first threshold, and
sets the commutation mode to the first commutation mode when the rotation speed of the motor decreases to a second threshold smaller than the first threshold when the commutation mode is the second commutation mode.

3. The motor drive control device according to claim 2, wherein
the control circuit stepwisely changes the current limit value from the first value to the second value when the zero crossing of the back electromotive voltage is no longer detectable after the commutation mode is switched from the first commutation mode to the second commutation mode.

4. The motor drive control device according to claim 3, wherein
the control circuit stepwisely changes the current limit value from the second value to the first value, once the zero crossing of the back electromotive voltage can be detected when the commutation mode is the second commutation mode.

5. The motor drive control device according to claim 4, wherein
a rate of change of the current limit value with respect to a time, when the current limit value switches from the second value to the first value, is larger than a rate of change of the current limit value with respect to a time when the current limit value switches from the first value to the second value.

6. The motor drive control device according to claim 2, wherein
the control circuit periodically determines whether the zero crossing of the back electromotive voltage is detected, increases the current limit value when the zero crossing of the back electromotive voltage is detected, and decreases the current limit value when the zero crossing of the back electromotive voltage is not detected.

7. A motor unit comprising:
the motor; and
the motor drive control device according to claim 1.

8. A motor drive control method for controlling a drive of a motor by a motor drive control device, the method comprising:
a first step of setting, by the motor drive control device, as a commutation mode, either
a first commutation mode for commutating a coil according to a detection result of a zero crossing of a back electromotive voltage of the coil of a motor, based on a rotation speed of the motor, or
a second commutation mode for commutating the coil according to a target energization period;
a second step of generating, by the motor drive control device, a drive control signal configured to control a drive of the motor;
a third step of setting, by the motor drive control device, a current limit value as a reference for limiting a current flowing through the coil; and
a fourth step of generating, by the motor drive control device, the drive control signal configured to stop excitation of the coil when the current flowing through the coil reaches the current limit value, wherein
the third step includes
a fifth step of setting, by the motor drive control device, the current limit value to a first value during a period with the commutation mode being the first commutation mode, and
a sixth step of setting, by the motor drive control device, the current limit value to a second value smaller than the first value during at least a part of the period in the second commutation mode.
